(19) United States
(12) Patent Application Publication
(10) Pub. No.: US 2024/0246161 A1
(43) Pub. Date: Jul. 25, 2024

(54) AN ELECTRICAL MACHINING DEVICE

(71) Applicant: TEXTURE JET LIMITED, Nottingham, Nottinghamshire (GB)

(72) Inventors: Jonathon Mitchell-Smith, Nottingham (GB); Jack FOSTER, Nottingham (GB)

(21) Appl. No.: 18/564,435

(22) PCT Filed: May 27, 2022
(86) PCT No.: PCT/GB2022/051362

§ 371 Date: Nov. 27, 2023

(30) Foreign Application Priority Data
May 27, 2021 (GB) 2107555.1

(51) Int. Cl. B23H 5/08

(52) U.S. Cl. CPC B23H 5/08

(57) ABSTRACT

An electrical machining device is provided for machining a surface of a workpiece. The electrical machining device includes a nozzle connectable to an electrolyte reservoir, the nozzle configured to dispense electrolyte towards a surface of a workpiece, in use, and an electrolyte flow path for conveying electrolyte from an electrolyte reservoir to the nozzle. The electrolyte flow path has a gas inlet therealong and the electrical machining device is configured to inject a gas into electrolyte flowing along the electrolyte flow path via the gas inlet, in use, so as to form gas bubbles in said electrolyte.

### FIELD OF THE INVENTION

The present invention relates to an electrical machining device for machining a surface of a workpiece.

### BACKGROUND OF THE INVENTION

Electrochemical machining and electrical machining, known as electrical arc discharge machining, are known processes for machining a surface of a workpiece. Electrochemical machining machines the surface of a workpiece using electrolysis, whereby two conductive electrodes of opposite polarities form a cell in an ionic solution in order to dissolve a surface of an electrode (i.e. the surface of a workpiece). Electrical arc discharge machining machines the surface of a workpiece using ablation caused by electrical arc discharge between two opposing conductive electrodes as current is attempted to be put through a dielectric therebetween. Through both of these processes, machining of surfaces can be used to roughen the surface to improve bonding for mounting components and applying coatings to the surface. Surface machining can also be used for modifying the optical and/or tribological properties of the surface, or polishing the surface to produce a homogenous surface finish. However, both of these processes require the surface of a workpiece to be conductive so as to form the counter electrode. Electrical machining typically requires complex pulsing and very high electrical power to create arc discharge, and may generate considerable amounts of heat at the surface of the workpiece as well as causing electrode wear. Electrical machining also traditionally requires the machining process to be carried out under submerged or confined conditions.

The present invention seeks to overcome or at least mitigate one or more problems associated with the prior art.

### SUMMARY OF THE INVENTION

According to a first aspect, there is provided an electrical machining device for machining a surface of a workpiece, the electrical machining device comprising: a nozzle connectable to an electrolyte reservoir, the nozzle configured to dispense electrolyte towards a surface of a workpiece, in use; and an electrolyte flow path for conveying electrolyte from an electrolyte reservoir to the nozzle; wherein the electrolyte flow path comprises a gas inlet therealong, and wherein, in use, the electrical machining device is configured to inject a gas into electrolyte flowing along the electrolyte flow path via the gas inlet so as to form gas bubbles in said electrolyte.

The gas bubbles are injected into the electrolyte upstream of the nozzle outlet port, for example upstream of the nozzle.

This arrangement is advantageously provides a new approach to large area surface texturing, by creating a high-speed discharge type machining phenomenon. This machining can be carried out on nonconductive surfaces without the need of adaption of the materials to be machined, only requiring simple power supply producing comparatively low electrical power. Thus, this arrangement creates a much more efficient and effective method of surface texturing large areas of nonconductive materials by inclusion of gas bubbles in the electrolyte stream to increase resistance at a discrete point causing arcing. In addition to texturing, the arrangement advantageously provides a means of deconstructing composite structures (or any nonconductive structure), such as for repair or end of life disposal.

The electrical machining device may be configured such that the gas is mixed with the electrolyte flowing along the electrolyte flow path. The gas may be mixed with the electrolyte such that the gas acts as an insulator.

Injecting gas bubbles into the electrolyte upstream of the nozzle enables a mixture of the electrolyte and gas bubbles to be conveyed to the outlet port of the nozzle so as to be dispensed towards the surface of the workpiece. The mixture of electrolyte and gas bubbles may have an increased resistivity compared to the electrolyte.

The mixture of the electrolyte and gas bubbles that is dispensed from the nozzle may comprises a concentration by volume of the gas bubbles that is less than the concentration by volume of the electrolyte.

The electrical machining device may be configured to inject gas into the electrolyte to reduce the conductivity of the electrolyte such that an electrical arc discharge can be generated, in use.

The electrical machining device may be configured for machining a surface of a conductive workpiece and for machining a surface of a nonconductive workpiece.

The electrical machining may be configured to apply a voltage to the nozzle such that the nozzle defines a first electrode.

The electrical machining may be configured to apply a voltage to surface electrolyte on a surface of a workpiece, in use, such that said surface electrolyte defines a second electrode.

The electrical machining may comprise a conductive member configured and arranged to apply a voltage to surface electrolyte on a surface of a workpiece, in use.

The electrical machining device may comprise a conductive member configured and arranged to contact the surface electrolyte so as to apply a voltage to said surface electrolyte on a surface of a workpiece, in use.

The conductive member may be configured and arranged to apply a voltage to surface electrolyte on a surface of a workpiece, in use, at a position laterally spaced from the nozzle.

The electrical machining device may be configured to dispense a jet of electrolyte from the nozzle towards a surface of a workpiece. It will be understood that the jet may be a continuous stream of the electrolyte containing the gas bubbles.

The electrical machining may be configured to apply a voltage to the nozzle and surface electrolyte on a surface of a workpiece, in use, to generate an electrical arc discharge.

The electrical arc discharge may be generated at the nozzle and impacts upon a surface of a workpiece, in use.

The nozzle may be arranged so as to be spaced apart from a surface of a workpiece, in use.

The electrical machining may comprise an electrolyte reservoir, and the electrolyte flow path may be connected between said electrolyte reservoir and the nozzle.

The electrical machining may comprise a gas source connected to the gas inlet for supplying gas thereto.

The electrical machining may be configured to inject compressed gas into the electrolyte flow path.

The compressed gas may comprise a pressure in the range 0.5-5 bar, for example approximately 2 bar.

The gas may be selected from one or more of compressed air, argon, nitrogen, helium, neon, krypton, xenon, radon, and carbon dioxide.

The gas may be inert or combustible.

The electrical machining may be configured to adjust the size of the gas bubbles formed in the electrolyte.

The gas inlet may define an area, and the size of said area may be adjustable.

The electrical machining may comprise a valve at or near the gas inlet to adjust the area of the gas inlet.

The electrical machining may be configured to adjust a pressure of the gas injected into the electrolyte flow path.

The electrolyte may comprise an ionic solvent.

The ionic solvent may have a conductivity of at least 8000 μS/cm.

The ionic solvent may comprise an inorganic salt solution.

The inorganic salt solution is of a molar concentration of at least 0.1M.

The inorganic salt solution may comprise compounds of the formula MX, where M is selected from Na+, K+, Ca2+, Mg2+, Cu2+ and Zn2+, or combinations thereof, and X is selected from F—, Cl—, Br—, I—, NO3- and SO42-, or combinations thereof.

The electrolyte may comprise a water based solution.

According to a second aspect there is provided an electrical machining process for machining a surface of a workpiece using an electrical machining device comprising a nozzle connectable to an electrolyte reservoir, an electrolyte flow path for conveying electrolyte from said electrolyte reservoir to the nozzle, said the electrolyte flow path comprising a gas inlet therealong, the electrical machining process comprising the steps of: conveying electrolyte along the electrolyte flow path; injecting a gas into the electrolyte within the electrolyte flow path via the gas inlet so as to form gas bubbles in said electrolyte; dispensing the electrolyte from the nozzle towards a surface of a workpiece; applying a charge to the nozzle and applying a charge to dispensed electrolyte solution on a surface of a workpiece at a position laterally spaced from the nozzle, such that the nozzle and the electrolyte on said surface of a workpiece form first and second electrodes; and generating an electrical arc discharge at the nozzle.

The process may comprise applying applies a voltage in the range 10-600V.

The process may comprise applying a current in the range 1-10 Amps.

The step of dispensing the electrolyte from the nozzle towards a surface of a workpiece may include dispensing a jet of electrolyte. The jet may be a continuous stream containing electrolyte.

The process may machine a surface of workpiece formed of a nonconductive or insulating material plastic.

The workpiece may be formed from a polymer or plastics material. The workpiece may be a fibre reinforced polymer composite material, for example a glass or carbon fibre reinforced polymer material.

### BRIEF DESCRIPTION OF THE DRAWINGS

Embodiments of the invention will now be described with reference to the accompanying drawings, in which:

FIG. 1 shows a schematic view of an electrical machining device according to an embodiment; and

FIG. 2 shows a schematic view of a nozzle of the electrical machining device of FIG. 1.

### DETAILED DESCRIPTION OF EMBODIMENT(S)

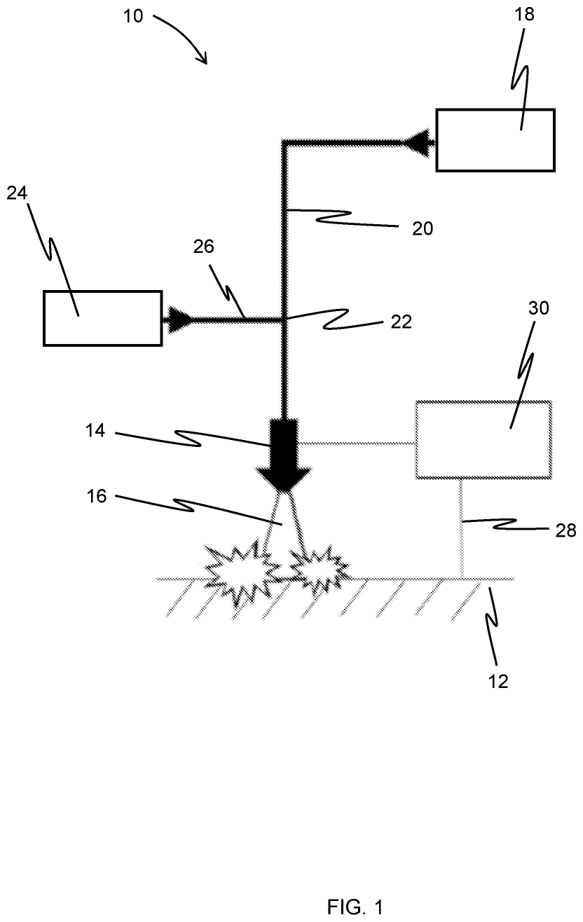

Referring firstly to FIG. 1, an electrical machining device 10 for machining a surface 12 of a workpiece is illustrated. The electrical machining device 10 may be considered to be an electrical arc discharge machining device.

The electrical machining device 10 includes a nozzle 14. The nozzle 14 is configured to dispense electrolyte, for example an electrolyte jet 16, towards the surface 12 of a workpiece. The nozzle 14 includes an outlet port 15 configured to dispense electrolyte, for example an electrolyte jet 16, towards the surface 12 of a workpiece. The jet 16 may be a continuous stream containing electrolyte. It will be appreciated that the nozzle 14 may be removably mounted to the electrical machining device 10 to allow for different nozzles to be used for different machining operations.

The electrical machining device 10 includes an electrolyte reservoir 18 for supplying electrolyte to the nozzle 14. The nozzle 14 is connected to the electrolyte reservoir 18. In alternative arrangements, it will be appreciated that the electrical machining device 10 may not include the electrolyte reservoir 18, and may instead simply be connectable to a reservoir separate from the electrical machining device 10. In such alternative arrangements, it will be appreciated that the nozzle 14 is connectable to the electrolyte reservoir.

An electrolyte flow path 20 is provided so as to convey electrolyte from the electrolyte reservoir 18 to the nozzle 14. The electrolyte flow path 20 is connected between said electrolyte reservoir 18 and the nozzle 14. The electrolyte flow path 20 is provided with a gas inlet 22 therealong. The gas inlet 22 is arranged upstream of the outlet port 15 of the nozzle 14, for example upstream of the nozzle 14. The electrical machining device 10 includes a gas source 24. The gas source 24 is connected to the gas inlet 22 via a gas flow path 26 for supplying gas to said gas inlet 22 and injecting gas into electrolyte flowing along the electrolyte flow path 20.

The electrical machining device 10 is configured to apply a charge to the nozzle 14 such that the nozzle 14 defines a first electrode. In alternative arrangements, the electrical machining device 10 may include a first electrode that is separate from the nozzle 14, and the electrical machining device 10 may be configured to apply a charge to said first electrode. The separate electrode may be positioned to be adjacent to the nozzle 14, for example.

As electrolyte is dispensed from the nozzle 14 towards the surface 12 of the workpiece, the dispensed electrolyte builds up on said surface 12. Put another way, dispensed electrolyte builds up as surface electrolyte 17 on the surface 12 of a work piece during use of the electrical machining device 10.

The electrical machining device 10 is configured to apply a charge to surface electrolyte 17 on the surface 12 of a workpiece. In this way, the surface electrolyte 17 forms a second electrode. The electrical machining device 10 includes a conductive member 28 arranged to terminate at or proximate to the surface 12 of a workpiece. The electrical machining device 10 is configured to apply a charge to said conductive member 28 to apply a charge to the surface electrolyte 17. The conductive member 28 is arranged to apply a charge to the surface electrolyte 17 at a position laterally spaced from the nozzle 14. The conductive member 28 may be referred to as a contact electrode. In alternative arrangements, any suitable configuration might be used to apply the voltage to the surface electrolyte.

The electrical machining device 10 is arranged such that the nozzle 14 is spaced apart from the surface 12 of a workpiece such that the first and second electrodes are spaced apart. The spacing between the electrode 14 and the surface 12 of the workpiece may affect the machining of said surface 12. The nozzle 14 may be moveable/adjustable such that the spacing between the nozzle 24 and the surface 12 can be adjusted to suit a particular machining operation.

The electrical machining device 10 is configured to apply an electrical charge to the first and second electrodes, in use, to generate an electrical arc discharge. Put another way, the electrical machining device 10 is configured to apply an electrical charge to the nozzle 14 and the surface electrolyte 17, in use, to generate an electrical arc discharge.

The electrolyte in the electrolyte jet 16 is conductive such that said electrolyte jet 16 provides an electrical connection between the first and second electrodes. Put another way, the electrolyte jet 16 provides an electrical connection between the nozzle 14 and the surface electrolyte 17.

The ionic solvent has a conductivity of at least 8000 μS/cm, for example at least 8500 μS/cm. In some arrangements, the ionic solvent has a conductivity of at least 9000 μS/cm. Providing the electrolyte with a conductivity above this minimum facilitates the generation of an electrical arc discharge.

The electrolyte solution may be provided in the form of an ionic solvent. In the embodiment, the electrolyte is a water-based electrolyte. The electrolyte is provided as a water-salt solution, for example a water based solution comprising an ionisable compound. It will be appreciated that any suitable electrolyte may be used, such as a substantially water free ionic solvent. It will be appreciated that any suitable solvent may be used that is capable of having a salt dissolved therein, for example the solvent may be a substantially water free solvent such as one or more of ethylene glycol, glycerol, methanol, ethanol, 1-propanol, 2-propanol and/or propylene glycol.

The ionic solvent comprises an inorganic salt solution. The inorganic salt solution is of a molar concentration of at least 0.1M, for example at least 0.5M. The inorganic salt solution comprises compounds of the formula MX. M is selected from Nat, K⁺, Ca²⁺, Mg²⁺, Cu²⁺ and Zn²⁺, or combinations thereof. X is selected from F⁻, Cl⁻, Br⁻, I⁻, NO³⁻ and SO₄²⁻, or combinations thereof. M will often by a group I metal, such as Na⁺ or K⁺ and X will often be a halogen, such as F⁻, Cl⁻, Br⁻, I⁻.

Whilst not essential, in order to maintain the sustainability of the machining process in an industrial setting, the electrolyte usefully may not be a highly toxic and/or a highly acidic/alkali solution. This also allows the electrolyte solution to maintain a low environmental impact solution. The electrolyte may be substantially neutral. Put another way, the pH of the electrolyte solution may be in the range of 5 to 9, or 6-8.

In order to be able to apply a charge to the nozzle 14 and the surface electrolyte 17, the electrical machining device 10 includes a power source 30. It will be appreciated that in order to supply power to the electrical machining device 10, the power source 30 may include one or more batteries or may be connectable to an external power source.

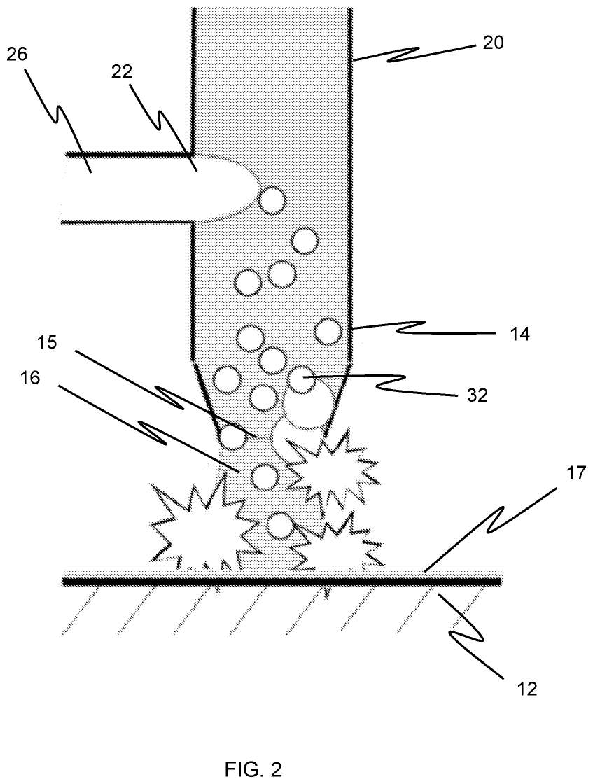

Referring now to FIG. 2, the nozzle 14 and gas inlet 18 are illustrated in more detail.

As discussed above, the electrical machining device 10 is configured to inject a gas into electrolyte flowing along the electrolyte flow path 20 via the gas inlet 22. The injection of gas into the electrolyte forms gas bubbles 32 in said electrolyte. In this way, a mixture of the gas bubbles 32 and electrolyte is conveyed to the nozzle 14, and the electrolyte jet 17 is also a mixture of gas bubbles 32 and electrolyte. It will be understood that in the present arrangement, the concentration by volume of the gas bubbles 32 in the mixture is less than the electrolyte.

Imparting or injecting gas bubbles 32 into the electrolyte jet 16 displaces the conductive electrolyte with a dielectric gas so as to reduce the conductivity of the electrolyte jet 16. Put another way, imparting or injecting inert gas bubbles 32 into the electrolyte jet 16 works to block the electrical path between the electrodes (i.e. between the nozzle 14 and the surface electrolyte 17) through the electrolyte jet 16.

The gas bubbles created in the electrolyte jet 16 result in an increase in the resistivity of the electrolyte solution (i.e. of the electrolyte jet 16). When the electrolyte jet 16 impacts the surface 12 of a workpiece, the gas bubbles 32 contained therein are expelled from the electrolyte onto the surface. This results in an increased conductivity of the surface electrolyte 17 compared to the electrolyte jet 16. The electrical machining device 10 is configured to inject a gas into electrolyte flowing along the electrolyte flow path 20 to increase the resistivity of the dispensed electrolyte solution (e.g. of the electrolyte jet 16) such that an electrical arc discharge can be generated. Put another way, the concentration of the gas bubbles 22 in the electrolyte increases the resistivity of the dispensed electrolyte solution (e.g. of the electrolyte jet 16) such that an electrical arc discharge can be generated.

It will be understood that the electrical arc discharge is generated between the nozzle 14 and the surface electrolyte 17. Put another way, the flow rate of the gas into the electrolyte flow path 20 and/or the concentration of gas bubbles within the electrolyte solution (i.e. of the electrolyte jet 16) is sufficient to enable an electrical arc discharge can be generated between the nozzle 14 and the surface electrolyte 17.

Due to the increased electrical resistance of the electrolyte jet 16 by the presence of the gas bubbles 32, when the electrical machining device 10 applies a sufficient voltage to the nozzle 14 and the surface electrolyte 17, an electrical arc discharge occurs. The electrical arc discharge occurs at the nozzle 14. The electrical arc discharge extends to the surface electrolyte below the nozzle 14 and impacts the surface 12 of the workpiece. The generated electrical arc discharge machines the surface 12 of the workpiece. In this way, electrical arc discharge machining is performed due to the presence of a conductive surface electrolyte, even if the surface 12 of the workpiece is not conductive. Examples of a nonconductive or insulating workpiece may be a polymer or plastics material, for example a fibre reinforced polymer composite material, for example a carbon fibre reinforced polymer material.

It will be appreciated that the electrical machining device 10 may be configured to inject compressed gas into the electrolyte flow path 20. Put another way, the gas source 24 may be a source of compressed gas. The compressed gas may have a pressure in the range 0.5-5 bar, for example approximately 2 bar. It will be appreciated that the electrical machining device 10 may be configured to adjust the pressure of the gas so as to adjust the size of the gas bubbles formed in the electrolyte.

The gas injected into the electrolyte flow path may be one or more of helium, neon, argon, krypton, xenon, radon, carbon dioxide, compressed air or any other suitable gas. The gas injected into the electrolyte flow path is used to increase the electrical resistance of the electrolyte jet 16, and it will be appreciated that a different gas may be used to machine different surfaces for different purposes. The gas may be an inert gas. The gas may be a combustible gas.

The electrical machining device 10 is configured to adjust the size of the gas bubbles 32 formed in the electrolyte. The inlet aperture of the gas inlet 22 may be adjustable to adjust the size of the gas bubbles 32 formed in the electrolyte. Put another way, gas inlet 22 defines an area, and the size of said area is adjustable. The electrical machining device 10 may include a valve that is operable to adjust the area of the gas inlet 22. The electrical machining device 10 may be configured to adjust the pressure of the gas injected into the electrolyte flow path 20 to adjust the size of the gas bubbles 32 formed in the electrolyte.

Although the electrical machining of a material surface has been described with reference to the electrical machining device illustrated in FIGS. 1 and 2, it will be appreciated that any suitable electrical machining device configured to dispense electrolyte solution towards a surface may be used. In some arrangements, the nozzle 14 form part of a machining unit that may be controlled by a robotic arm 52, e.g. as a part of an automated production line. In such arrangements, the machining unit may be configured such that it is able to be moved over a surface of a workpiece by the robotic arm without having to remove and the re-attach said machining unit. This arrangement enables machining to be carried out continuously over the surface.

In further arrangements, the nozzle 14 may form part of a machining unit that is configured to be driven over the surface. In order to drive the machining unit over the surface, a drive arrangement may be provided to move the machining unit over said surface.

An electrical machining process for machining a surface 12 of a workpiece using an electrical machining device 10 will now be described.

Electrolyte is conveyed along the electrolyte flow path 20. A gas is injected into the electrolyte within the electrolyte flow path 20 via the gas inlet 22. The injection of the gas into the electrolyte forms gas bubbles 32 in said electrolyte.

The electrolyte containing the gas bubbles 32 continues to flow along the electrolyte flow path 20 into the nozzle 14.

Electrolyte is dispensed from the nozzle 14 towards the surface 12 of a workpiece. Put another way, the nozzle 14 dispenses an electrolyte jet 16 towards the surface 12 of a workpiece.

The electrical machining device 10 applies a charge to the nozzle 14. The electrical machining device 10 applies a charge to dispensed electrolyte solution on the surface 12 of a workpiece. The electrical machining device 10 applies a charge to dispensed electrolyte at a position laterally spaced from the nozzle 14. In this way, the nozzle 14 and the electrolyte on said surface 12 form first and second electrodes of a cell defining a gap therebetween. The electrical machining device 10 applies an electrical charge to the first and second electrodes, in use, to generate an electrical arc discharge.

The electrical machining device 10 may be configured to apply a potential of less than 600 V. Often, the electrical machining device 10 may apply a potential in the range 10V to 600 V.

The electrical machining device 10 may be configured to apply a charge of less than 10 A. Often, the electrical machining device 10 may apply a charge in the range 1-10 A.

Although the invention has been described above with reference to one or more preferred embodiments, it will be appreciated that various changes or modifications may be made without departing from the scope of the invention as defined in the appended claims.

1. An electrical machining device for machining a surface of a workpiece, the electrical machining device comprising:
a nozzle connectable to an electrolyte reservoir, the nozzle comprising an outlet port configured to dispense electrolyte towards a surface of a workpiece, in use; and
an electrolyte flow path for conveying electrolyte from an electrolyte reservoir to the nozzle;
wherein the electrolyte flow path comprises a gas inlet upstream of the outlet port of the nozzle, and
wherein, in use, the electrical machining device is configured to inject a gas into electrolyte flowing along the electrolyte flow path via the gas inlet so as to form gas bubbles in said electrolyte.

2. The electrical machining device according to claim 1, configured, in use, to inject a predetermined flow-rate of gas into electrolyte flowing along the electrolyte flow path to reduce the conductivity of said electrolyte for enabling an electrical arc discharge to be generated.

3. The electrical machining device according to claim 1, configured to apply a voltage to the nozzle such that the nozzle defines a first electrode.

4. The electrical machining device according to claim 1, configured to apply a voltage to surface electrolyte on a surface of a workpiece, in use, such that said surface electrolyte defines a second electrode.

5. The electrical machining device according to claim 4, comprising a conductive member configured and arranged to contact surface electrolyte so as to apply a voltage to surface electrolyte on a surface of a workpiece, in use, for example at a position laterally spaced from the nozzle.

6. The electrical machining device according to claim 1, configured to apply a voltage to the nozzle and surface electrolyte on a surface of a workpiece, in use, to generate an electrical arc discharge.

7. The electrical machining device according to claim 1, wherein the nozzle is arranged so as to be spaced apart from a surface of a workpiece, in use.

8. The electrical machining device according to claim 1, configured to inject compressed gas into the electrolyte flow path.

9. The electrical machining device according to claim 8, wherein the compressed gas comprises a pressure in the range 0.5-5 bar, for example approximately 2 bar.

10. The electrical machining device according to claim 1, wherein the gas is selected from one or more of compressed air, argon, nitrogen, helium, neon, krypton, xenon, radon, and carbon dioxide.

11. The electrical machining device according to claim 1, wherein mixture of electrolyte and the gas bubbles comprises a concentration by volume of the gas bubbles that is less than the concentration by volume of the electrolyte.

12. The electrical machining device according to claim 1, wherein the gas inlet defines an area, and the size of said area is adjustable, optionally comprising a valve at or near the gas inlet to adjust the area of the gas inlet.

13. The electrical machining device according to claim 1, configured to adjust a pressure of the gas injected into the electrolyte flow path.

14. The electrical machining device according to claim 1, wherein the electrolyte comprises an ionic solvent, preferably the ionic solvent has a conductivity of at least 8000 μS/cm.

15. The electrical machining device according to claim 1, wherein the electrolyte comprises an ionic solvent, and wherein the ionic solvent comprises an inorganic salt solution, optionally wherein the inorganic salt solution is of a molar concentration of at least 0.1M.

16. The electrical machining device according to claim 15, wherein the inorganic salt solution comprises compounds of the formula MX, where M is selected from Na⁺, K⁺, Ca²⁺, Mg²⁺, Cu²⁺ and Zn²⁺, or combinations thereof, and X is selected from F⁻, Cl⁻, Br⁻, I⁻, NO₃⁻ and SO₄²⁻, or combinations thereof.

17. The electrical machining device according to claim 1, wherein the electrolyte comprises a water based solution.

18. An electrical machining process for machining a surface of a workpiece using an electrical machining device comprising a nozzle connectable to an electrolyte reservoir, an electrolyte flow path for conveying electrolyte from said electrolyte reservoir to the nozzle, said the electrolyte flow path comprising a gas inlet therealong, the electrical machining process comprising the steps of:
conveying electrolyte along the electrolyte flow path;
injecting a gas into the electrolyte within the electrolyte flow path via the gas inlet so as to form gas bubbles in said electrolyte;
conveying the mixture of electrolyte and gas bubbles to an outlet port of the nozzle;
dispensing the mixture of electrolyte and gas bubbles from the outlet port towards the surface of the workpiece;
applying a charge to the nozzle and applying a charge to dispensed surface electrolyte solution on a surface of a workpiece, such that the nozzle and the surface electrolyte on said surface of a workpiece form first and second electrodes; and
generating an electrical arc discharge at the nozzle which impacts on the surface of the workpiece.

19. The electrical machining process according to claim 19, comprising the step of applying a voltage in the range 10-600V and/or applying a current in the range 1-10 Amps.

20. The electrical machining process according to claim 18, wherein the surface of the workpiece is an insulating or non-conductive surface.
